(19) United States
(12) Patent Application Publication
(10) Pub. No.: US 2023/0162105 A1
(43) Pub. Date: May 25, 2023

(54) INFORMATION PROCESSING SYSTEM AND METHOD FOR ASSIGNING RESPONDER TO INQUIRY

(71) Applicant: Hitachi, Ltd., Tokyo (JP)

(72) Inventors: Tsukuru YUASA, Tokyo (JP); Kouichi KONDOU, Tokyo (JP)

(21) Appl. No.: 17/901,581

(22) Filed: Sep. 1, 2022

(30) Foreign Application Priority Data
Nov. 22, 2021 (JP) 2021-189409

(51) Int. Cl. G06Q 10/06

(52) U.S. Cl. CPC G06Q 10/063112

(57) ABSTRACT

A system assigns a responder having a skill required for an inquiry to respond to the inquiry, based on an inquiry response history and, in the case where an escalation is necessary, executes the escalation including assigning the responder, having the skill required for the inquiry, as an escalation destination, based on the history. The history includes information representing the skill and a statistic of a response period for each responder, each escalation, and each escalation path. Every time answering to the inquiry is performed, the system updates the history, based on the skill, the response period required for an inquiry response by the responder, and, in the case where the escalation is performed, the response period of the escalation and the response period of the escalation path.

### CROSS-REFERENCE TO PRIOR APPLICATION

This application relates to and claims the benefit of priority from Japanese Patent Application number 2021-189409, filed on Nov. 22, 2021 the entire disclosure of which is incorporated herein by reference.

### BACKGROUND

The present invention relates generally to a technique for assigning a responder.

Currently, in a task (service) in which an inquiry is received from a user (e.g., a customer such as a consumer) and an answer is returned, a person having received the inquiry assigns himself/herself as a responder, based on the type of the inquiry (e.g., the person answers the inquiry as the responder), or the person selects, based on an empirical determination of the person, another person as a responder, and assigns the other person to respond to the inquiry.

Note that a technique for assigning a responder for a failure message or error information generated from an apparatus is disclosed in each of PTL 1 and PTL 2.

### PATENT LITERATURE

[PTL 1] Japanese Patent Application Publication No. 2013-54425
[PTL 2] Japanese Patent Application Publication No. 2020-129246

### SUMMARY

In the case where the inquiry is related to a failure of an apparatus, it is conceivable to assign a responder to the inquiry by using the technique disclosed in each of PTL 1 and PTL 2.

However, the inquiry made by a customer is not limited to a fixed phrase such as the failure message or the error information generated from the apparatus, and hence, even when the technique disclosed in each of PTL 1 and PTL 2 is used, an appropriate person is not necessarily assigned as a responder first. In the case where the assigned person is not appropriate as the responder, an escalation from the assigned person to another person occurs. Consequently, it takes time before the inquiry is answered. In addition, the other person is not necessarily an appropriate responder and, therefore, reoccurrence of the escalation may be repeated. As a result, it takes more time before the inquiry is answered. Because of the above reasons, it is desired to reduce the number of times of occurrence of the escalation for one inquiry (preferably reduce the number of times thereof to zero), i.e., shorten an escalation path for one inquiry (preferably reduce the length of the escalation path to zero).

An information processing system receives an inquiry of a user, and assigns a responder having a skill required for the received inquiry to respond to the inquiry, based on inquiry response history information which is information serving as a history of an inquiry response. The inquiry response history information includes, for each responder, information representing the skill of the responder and a statistic of a response period which is a period required for the inquiry response. In addition, the inquiry response history information includes, for each escalation, information representing the skill required for an escalation-target inquiry response, information representing the responder of each of an escalation source and an escalation destination of the escalation, and a statistic of a response period of the escalation. Further, the inquiry response history information includes, for each escalation path, information representing the skill required for the escalation-target inquiry response, information representing the order of one or more responders constituting the escalation path, and a statistic of a response period of the escalation path. The information processing system determines whether or not an escalation from an assigned responder to another responder is necessary and, in the case where the escalation is necessary, executes the escalation including assigning the responder having the skill required for the received inquiry as the escalation destination based on the inquiry response history information. The information processing system transmits an answer for the received inquiry from the responder to the user. Every time the inquiry of the user is received and then the inquiry is answered to the user, the information processing system updates the inquiry response history information, based on the skill required for the response to the received inquiry, the skill of the responder assigned to the inquiry, the response period required for the inquiry response by the responder, and, in the case where one or more escalations are performed for the inquiry, the response period of each escalation and the response period of the escalation path.

According to the present invention, it is possible to reduce the number of times of occurrence of an escalation for an inquiry to thereby return an appropriate answer to the inquiry quickly.

### BRIEF DESCRIPTION OF THE DRAWINGS

FIG. 1 shows the configuration of an overall system including an information processing system according to an embodiment;

FIG. 2 shows the configuration of the information processing system according to the embodiment;

FIG. 3 shows the configuration of an inquiry response table;

FIG. 4 shows the configuration of a responder table;

FIG. 5 shows the configuration of a skill classification table;

FIG. 6 shows the configuration of an inquiry type table;

FIG. 7 shows the configuration of a word list table;

FIG. 8 shows the configuration of an escalation table;

FIG. 9 shows the configuration of an escalation path table;

FIG. 10 shows a flowchart of inquiry response processing;

FIG. 11 shows a flowchart of initial assignment processing;

FIG. 12 shows a flowchart of escalation processing;

FIG. 13 shows a flowchart of learning processing;

FIG. 14 schematically shows an example of a difference between a comparative example and the embodiment; and

FIG. 15 shows an example of the outline of the embodiment.

### DESCRIPTION OF EMBODIMENTS

In the following description, an “interface apparatus” may be one or more interface devices. The one or more interface devices may be at least one of the following.
One or more I/O (Input/Output) interface devices. The I/O (Input/Output) interface device is an interface device for at least one of an I/O device and a remote display computer. The I/O interface device for the display computer may be a communication interface device. At least one I/O device may also be a user interface device, e.g., any of input devices such as a keyboard and a pointing device, and an output device such as a display device.
One or more communication interface devices. One or more communication interface devices may be one or more communication interface devices of the same type (e.g., one or more network interface cards (NIC)), and may also be two or more communication interface devices of different types (e.g., the NIC and a host bus adapter (HBA)).

In addition, in the following description, a “memory” may be one or more memory devices which are examples of one or more storage devices, and may be typically a main storage devices. At least one memory device in the memory may be a volatile memory device and may also be a non-volatile memory device.

Further, in the following description, a “persistent storage apparatus” may be one or more persistent storage devices which are examples of one or more storage devices. The persistent storage device may be typically a non-volatile storage device (e.g., an auxiliary storage device) and, specifically, the persistent storage device may be, e.g., a hard disk drive (HDD), a solid state drive (SSD), a non-volatile memory express (NVME) drive, or a storage class memory (SCM).

In addition, in the following description, a “storage apparatus” may be, of the memory and the persistent storage apparatus, at least the memory.

Further, in the following description, a “processor” may be one or more processor devices. At least one processor device may be typically a microprocessor device such as a central processing unit (CPU), but may also be a processor device of another type such as a graphics processing unit (GPU). At least one processor device may be a single-core or multi-core processor device. At least one processor device may be a processor core. At least one processor device may be a processor device in a broad sense such as a circuit having the set of gate arrays which performs part or the whole of processing and is written in hardware description language (e.g., a field-programmable gate array (FPGA), a complex programmable logic device (CPLD), or an application specific integrated circuit (ASIC)).

In addition, in the following description, while there are cases where a function is described by using an expression a “yyy section”, the function may be implemented by execution of one or more computer programs by a processor, may be implemented by one or more hardware circuits (e.g., the FPGA or the ASCI), and may also be implemented by a combination thereof. In the case where the function is implemented by execution of the programs by the processor, predetermined processing is performed while a storage apparatus and/or an interface apparatus is appropriately used, and hence the function may be regarded as at least part of the processor. Processing described by using the function as the subject may be regarded as processing performed by a processor or an apparatus having the processor. The program may be installed from a program source. The program source may be, e.g., a program distribution computer or a recording medium which can be read by a computer (e.g., a non-transitory recording medium). The description of each function is an example, and a plurality of functions may be integrated into one function and one function may also be divided into a plurality of functions.

Further, in the following description, while there are cases where information in which an output is obtainable for an input is described by using an expression such as an “xxx table”, the information may be data having any structure (may be, e.g., structured data or non-structured data), and the information may also be a neural network which generates an output for an input, a genetic algorithm, or a learning model represented by the random forest. Consequently, the “xxx table” can be said to be “xxx information”. In addition, in the following description, the configuration of each table is an example, and one table may be divided into two or more tables and all or part of two or more tables may be one table.

Further, in the following description, an “inquiry” is the set of one or more questions. One or more answers corresponding to one or more questions individually are answers for the “inquiry”.

Hereinbelow, an embodiment of the present invention will be described by using the drawings. Note that, in the drawings, the designations of elements are appropriately simplified or shown by using signs due to limited sheet space.

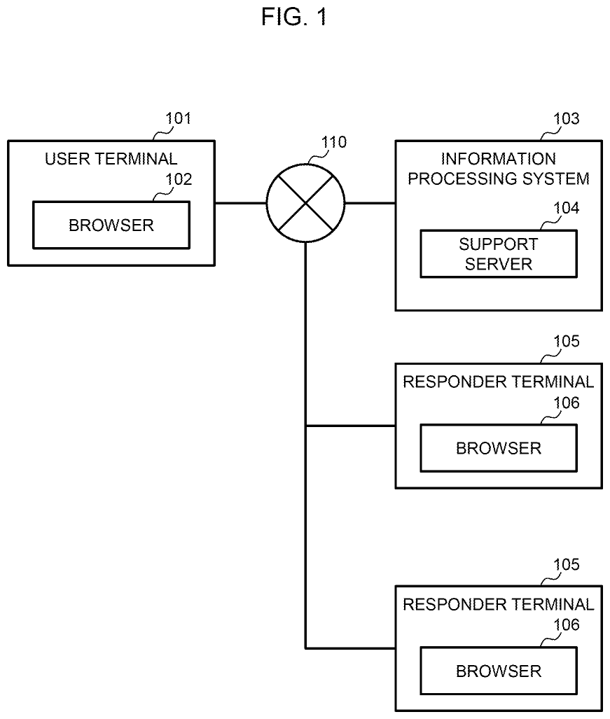

FIG. 1 shows the configuration of an overall system including an information processing system according to the embodiment.

An information processing system 103 communicates with a user terminal 101 and a responder terminal 105 via a communication network 110 (e.g., the Internet).

The information processing system 103 is a physical computer system (one or more physical computers) in the present embodiment, but the information processing system 103 may also be a logical computer system (e.g., a cloud computing system) implemented in a physical computer system (e.g., the structure of cloud computing). The information processing system 103 has a support server 104. The support server 104 receives an inquiry from a user, assigns the inquiry to a responder, receives an answer from the responder (or the final responder assigned as a result of one or more escalations), and returns the answer received from the responder to the user. In the present embodiment, the “user” denotes a person who makes an inquiry. The “responder” denotes a person who returns the answer for the inquiry assigned to the user, or a person who is involved in an escalation. In addition, the “escalation” denotes that the inquiry assigned to the responder is assigned to another responder from the responder, in other words, an assignment destination (person in charge) of the inquiry is changed from the responder to another responder. The “escalation” may be a pair of an escalation source and an escalation destination. An “escalation path” denotes the order of assignment of responders. Therefore, the escalation path is a path having a directed acyclic graph (DAG) structure, i.e., a path in which a responder is a node and an escalation (the change of the assignment destination from the escalation source to the escalation destination) is a link. In addition, the “assignment” may be an initial assignment or an escalation assignment (an assignment serving as an escalation).

The user terminal 101 is an information processing terminal (e.g., a computer such as a personal computer or a smartphone) of a user. In the user terminal 101, a browser 102 (e.g., a Web browser) is executed. The user can input an inquiry into the support server 104 or receive an answer for the inquiry from the support server 104 via a user interface (UI) displayed by the browser 102.

The responder terminal 105 is an information processing terminal (e.g., a computer such as a personal computer or a smartphone) of a responder. In the responder terminal 105, a browser 106 (e.g., a Web browser) is executed. The responder can receive the assigned inquiry of the user from the support server 104 or input the answer for the inquiry into the support server 104 via a UI displayed by the browser 106.

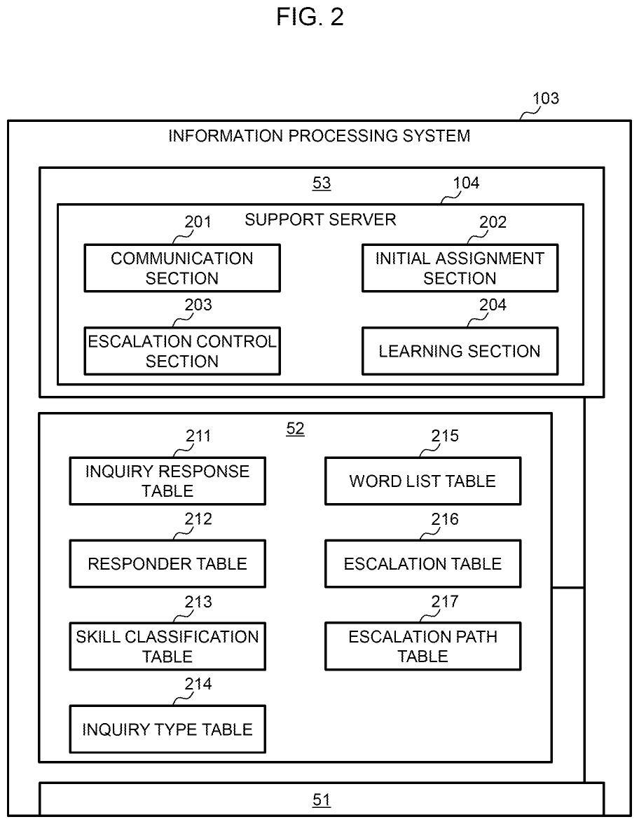

FIG. 2 shows the configuration of the information processing system 103.

The information processing system 103 includes an interface apparatus 51, a storage apparatus 52, and a processor 53 coupled to the interface apparatus 51 and the storage apparatus 52.

The interface apparatus 51 is coupled to the communication network 110.

The storage apparatus 52 stores information which is input to and output from the processor 53, and a computer program executed by the processor 53. Examples of the information stored in the storage apparatus 52 include an inquiry response table 211, a responder table 212, a skill classification table 213, an inquiry type table 214, a word list table 215, an escalation table 216, and an escalation path table 217. The details of the tables 211 to 217 will be described later.

The processor 53 executes the computer program, and the support server 104 is thereby implemented. The support server 104 has a communication section 201, an initial assignment section 202, an escalation control section 203, and a learning section 204. The details of these functions 201 to 204 will be described later.

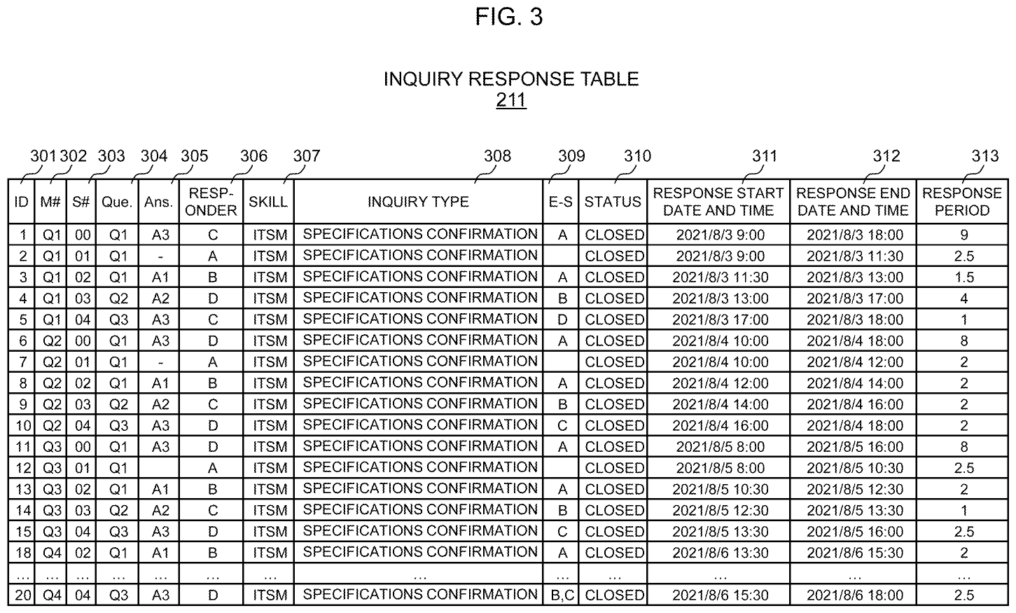

FIG. 3 shows the configuration of the inquiry response table 211.

The inquiry response table 211 has a record of each of assignments of one or more questions constituting the inquiry for each inquiry. Each record retains pieces of information such as an ID 301, a master number 302, a sub-number 303, a question 304, an answer 305, a responder 306, a skill classification 307, an inquiry type 308, an escalation source 309, a status 310, a response start date and time 311, a response end date and time 312, and a response period 313. Hereinbelow, a description will be made by using one assignment as an example (“assignment of concern” in the description of FIG. 3).

The ID 301 represents an ID of a record corresponding to the assignment of concern. The master number 302 represents an identification number of an inquiry including a question subjected to the assignment of concern. The sub-number 303 represents an identification number of the assignment of concern. In each inquiry, each of assignments having the sub-numbers 303 of “01” and subsequent to “01” is an initial assignment or an escalation assignment. For each inquiry, a record including the sub-number 303 of “00” will be described later.

The question 304 represents a question itself subjected to the assignment of concern (or a link to the question). The answer 305 represents an answer itself for the question subjected to the assignment of concern (or a link to the answer).

The responder 306 represents the full name of a responder who has produced (input) an answer for the question subjected to the assignment of concern. The skill classification 307 represents the classification of a skill required for the production of the answer for the question subjected to the assignment of concern (typically a skill required to understand and answer the question). The inquiry type 308 represents the type of an inquiry including the question subjected to the assignment of concern (or the question itself).

The escalation source 309 represents a responder name (the full name of the responder) serving as the escalation source of the question subjected to the assignment of concern. The status 310 represents the status of the assignment of concern (e.g., “pending” (during response), “escalation completion” (means that an escalation is completed), and “closed” (means that the final answer for the inquiry is completed)).

The response start date and time 311 represents a date and time when a response to the assignment of concern (e.g., the production of the answer for the question subjected to the assignment of concern) is started, typically a date and time when the assignment of concern is performed and the question is received by the responder (e.g., a date and time when the question subjected to the assignment of concern is viewed by the assigned responder). The response end date and time 312 represents a date and time when the response to the assignment of concern is ended, typically a date and time when the answer is input or a date and time when an escalation is performed.

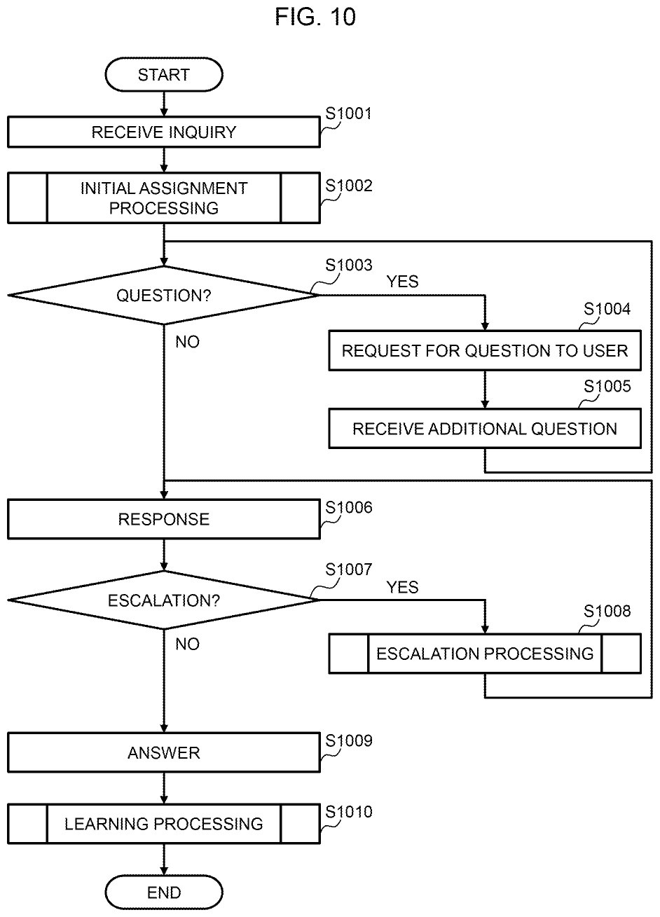

The response period 313 represents a period required for an inquiry response, specifically a period from the date and time represented by the response start date and time 311 to the date and time represented by the response end date and time 312. Specifically, for example, with regard to the question subjected to the assignment of concern, the response period 313 may be any of the following.
A period from when the response to the question is started by the responder (e.g., S1006 in FIG. 10 is started) to when the communication section 201 receives the answer for the question from the responder.
A period from when the response to the question is started by the responder to when the answer for the question is not input and the question is escalated to another responder.

The record is added to the inquiry response table 211 (or information is added to the record) in the case where the question from the user is received, in the case where the initial assignment is performed, in the case where the escalation is performed, and in the case where the answer for the question is input.

It is possible to identify whether or not the escalation related to an inquiry has occurred, and the escalation path of the inquiry in the case where the escalation has occurred from records having the same value of the master number 302 (note that the record having the sub-number 303 of “00” is excluded). For example, according to records of the inquiry having the master number 302 of “Q1” (records having the IDs “2” to “5”), the escalation path is A→B→D→C. For example, according to the record having the ID “3”, it can be seen that the escalation from the responder “A” to the responder “B” is performed. In addition, in the case where the escalation does not occur, the value of the escalation source 309 is set to “—”.

In each inquiry, the record having the sub-number 303 of “00” is a record serving as a counting result of records having the sub-numbers 303 of “01” and subsequent to “01” for the inquiry, i.e., a record representing information on the entire escalation path of the inquiry. For example, in each inquiry, the record having the sub-number 303 of “00” is as follows. The question 304 represents the first question in the inquiry. The answer 305 represents the answer for the last question. The responder 306 represents the full name of the last responder (the responder serving as the terminal end of the escalation path). The escalation source 309 represents the full name of the responder assigned in the initial assignment. The response start date and time 311 is the same as the response start date and time 311 in the record corresponding to the initial assignment. The response end date and time 312 is the same as the response end date and time 312 in the record corresponding to the last escalation assignment. The response period 313 represents a period from the date and time represented by the response start date and time 311 to the date and time represented by the response end date and time 312 (i.e., the total sum of the response periods 313 in the records having the sub-numbers 303 of “01” and subsequent to “01”) for the record having the sub-number 303 of “00”.

In addition, according to the inquiry response table 211 in FIG. 3, the escalation is performed on a per-question in the inquiry basis. However, the escalation is not limited to the above basis and, for example, the escalation may also be performed on a per-whole inquiry basis.

In addition, in the present embodiment, while the inquiry is constituted by one or more questions, inputting of answers for all of the one or more questions may denote inputting of “the answer for the inquiry”, and performing the escalation for at least one question in the inquiry may denote performing the escalation for the inquiry. That is, it follows that the escalation of the inquiry occurs in the case where, even when answers are input for part of the inquiry by the assigned responder, all of the answers are not input.

The escalation path table 218 is constructed and updated based on the above-described inquiry response table 211.

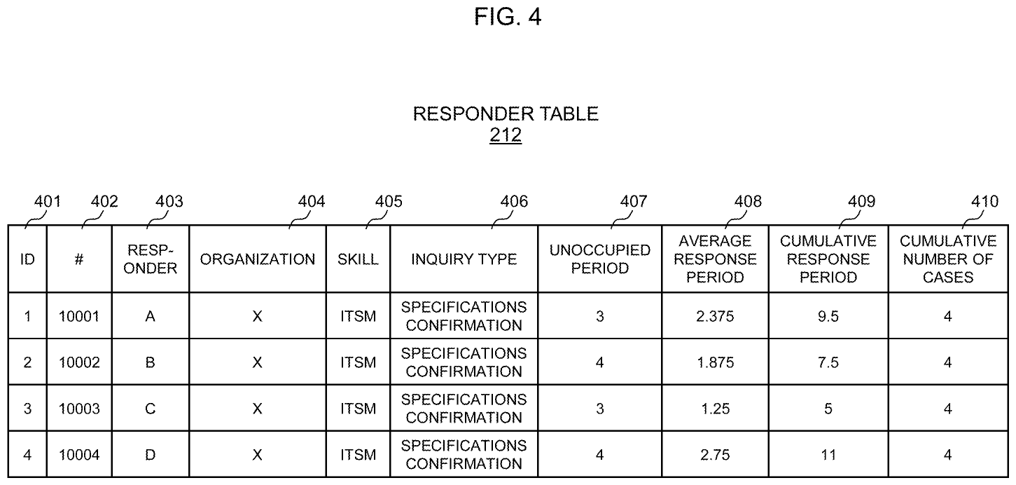

FIG. 4 shows the configuration of the responder table 212.

The responder table 212 has a record for each responder. Each record retains pieces of information such as an ID 401, a responder number 402, a responder 403, an organization 404, a skill classification 405, an inquiry type 406, an unoccupied period 407, an average response period 408, a cumulative response period 409, and the cumulative number of cases 410. Hereinbelow, a description will be made by using one responder as an example (“responder of concern” in the description of FIG. 4).

The ID 401 represents an ID of a record corresponding to the responder of concern. The responder number 402 represents an identification number of the responder of concern. The responder 403 represents the full name of the responder of concern. The organization 404 represents an organization of the responder of concern.

The skill classification 405 represents the classification of a skill of the responder of concern. The inquiry type 406 represents the type of an inquiry (or a question) to which the responder of concern can respond.

The unoccupied period 407 represents an unoccupied period of the responder of concern before a predetermined date and time (e.g., 24:00). The period represented by the unoccupied period 407 is shortened by, e.g., the learning section 204 as time elapses (as a period before the predetermined date and time is shortened).

The average response period 408 represents an average of the response periods 313 in all records in which the full name of the responder of concern is recorded as the responder 306 (records in the inquiry response table 211 (note that the record having the sub-number 303 of “00” is excluded)). The cumulative response period 409 represents a cumulative value of the response periods 313 in all records in which the full name of the responder of concern is recorded as the responder 306 (records in the inquiry response table 211 (note that the record having the sub-number 303 of “00” is excluded)). The cumulative number of cases 410 represents the number of records in which the full name of the responder of concern is recorded as the responder 306 (records in the inquiry response table 211 (note that the record having the sub-number 303 of “00” is excluded)).

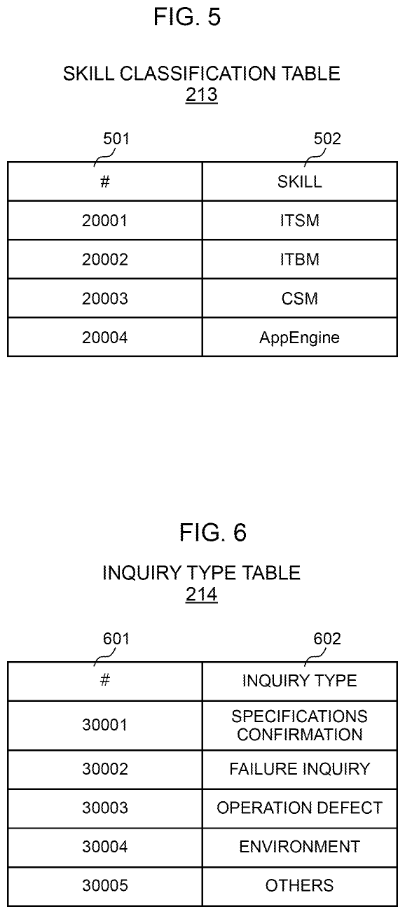

FIG. 5 shows the configuration of the skill classification table 213.

The skill classification table 213 has a record for each skill classification. Each record retains pieces of information such as a skill classification number 501 and a skill classification 502. Hereinbelow, a description will be made by using one skill classification as an example (“skill classification of concern” in the description of FIG. 5).

The skill classification number 501 represents an identification number of the skill classification of concern. The skill classification 502 represents the skill classification of concern.

FIG. 6 shows the configuration of the inquiry type table 214.

The inquiry type table 214 has a record for each inquiry type. Each record retains pieces of information such as an inquiry type number 601 and an inquiry type 602. Hereinbelow, a description will be made by using one inquiry type as an example (“inquiry type of concern” in the description of FIG. 6).

The inquiry type number 601 represents an identification number of the inquiry type of concern. The inquiry type 602 represents the inquiry type of concern.

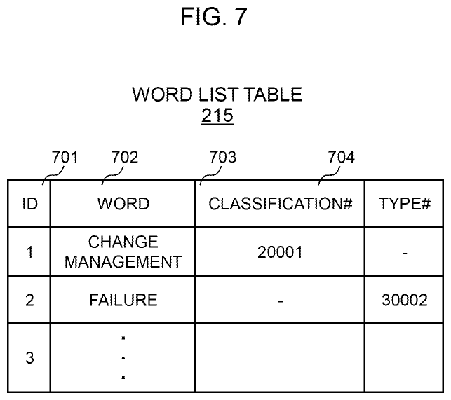

FIG. 7 shows the configuration of the word list table 215.

The word list table 215 has a record for each word. Each record retains pieces of information such as an ID 701, a classification number 703, and a type number 704.

Hereinbelow, a description will be made by using one word as an example (“word of concern” in the description of FIG. 7).

The ID 701 represents an ID of a record of the word of concern. A word 702 represents the word of concern. The classification number 703 represents an identification number of the classification of a skill required to produce an answer for an inquiry including the word of concern. The type number 704 represents an identification number of the type of the inquiry including the word of concern.

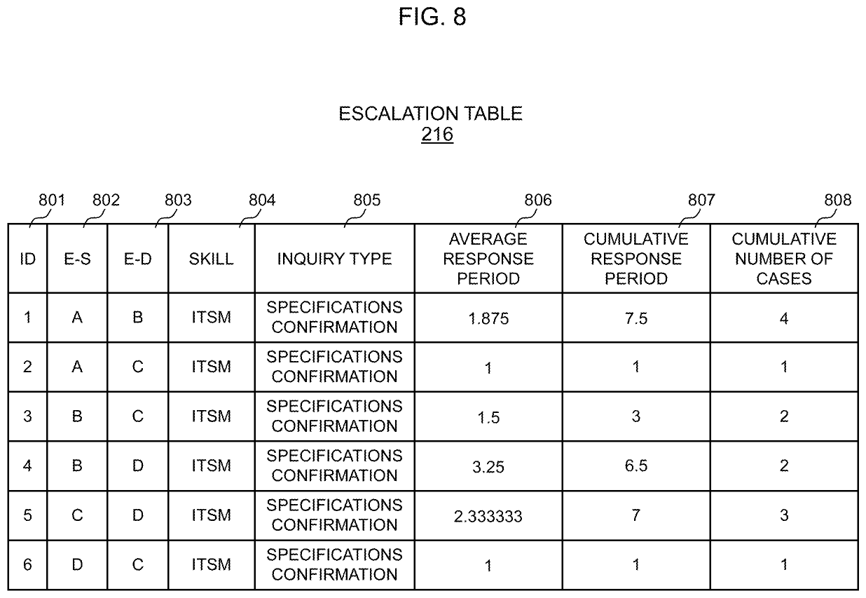

FIG. 8 shows the configuration of the escalation table 216.

The escalation table 216 has a record for each escalation. Each record retains pieces of information such as an ID 801, an escalation source 802, an escalation destination 803, a skill classification 804, an inquiry type 805, an average response period 806, a cumulative response period 807, and the cumulative number of cases 808. Hereinbelow, a description will be made by using one escalation as an example (“escalation of concern” in the description of FIG. 8).

The ID 801 represents an ID of a record of the escalation of concern. The escalation source 802 represents the full name of the responder serving as the escalation source of the escalation of concern. The escalation destination 803 represents the full name of the responder serving as the escalation destination of the escalation of concern. The skill classification 804 has the same value as that of the skill classification 405 of the responder serving as the escalation destination of the escalation of concern. The inquiry type 805 has the same value as that of the inquiry type 406 of the responder serving as the escalation destination of the escalation of concern.

The average response period 806 represents an average of the response periods 313 in all records corresponding to the escalation of concern (records in the inquiry response table 211 (note that the record having the sub-number 303 of “00” is excluded)). The cumulative response period 807 represents a cumulative value of the response periods 313 in all records corresponding to the escalation of concern (records in the inquiry response table 211 (note that the record having the sub-number 303 of “00” is excluded)). The cumulative number of cases 808 represents the number of records corresponding to the escalation of concern (records in the inquiry response table 211 (note that the record having the sub-number 303 of “00” is excluded)). Note that, with regard to one escalation, “the response period” denotes a period required until an escalation is performed from the escalation source to the escalation destination and an answer is input by the responder serving as the escalation destination or an escalation to another responder is performed.

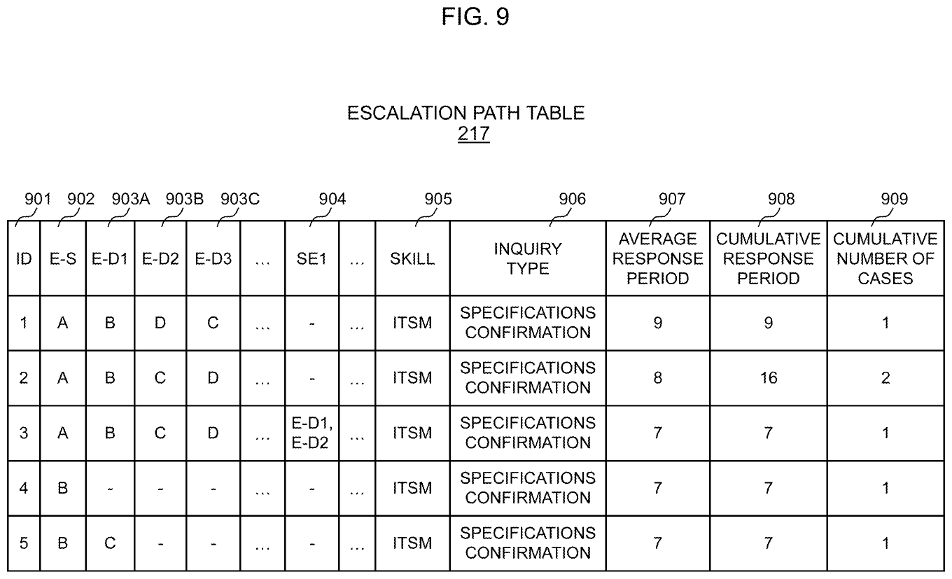

FIG. 9 shows the configuration of the escalation path table 217.

The escalation path table 217 has a record for each escalation path. Each record retains pieces of information such as an ID 901, an escalation source 902, an escalation destination 903, a simultaneous escalation 904, a skill classification 905, an inquiry type 906, an average response period 907, a cumulative response period 908, and the cumulative number of cases 909. Hereinbelow, a description will be made by using one escalation path as an example (“escalation path of concern” in the description of FIG. 9).

The ID 901 represents an ID of a record of the escalation path of concern. The escalation source 902 represents the full name of the first responder of the escalation path of concern. The escalation destination 903 represents the full name of the responder for each responder other than the first responder in the escalation path of concern. The order of the escalation destinations 903 is the same as the order of the responders in the escalation path of concern.

The simultaneous escalation 904 represents the column name of each of a plurality of the escalation destinations having the same escalation source in the escalation of concern.

The skill classification 905 has the same value as that of the skill classification 405 of the last responder of the escalation path of concern. The inquiry type 906 has the same value as that of the inquiry type 406 of the last responder of the escalation path of concern.

The average response period 907 represents an average of a period from the start of response of the first responder of the escalation path of concern to the end of response of the final responder thereof. The cumulative response period 908 represents a cumulative value of periods from the start of response of the first responder of the escalation path of concern to the end of response of the final responder thereof. The cumulative number of cases 909 represents the number of inquiries which have caused the escalation path of concern. Specifically, for example, the learning section 204 acquires a record having the sub-number 303 of “00” from the inquiry response table 211 correspondingly to the escalation path of concern. The learning section 204 sets the number of acquired records as the cumulative number of cases 909, sets the total value of the response periods 313 in the acquired records as the cumulative response period 908, and sets a value obtained by dividing the cumulative response period 908 by the cumulative number of cases 909 as the average response period 907. When it is assumed that the escalation path of concern is the escalation path having the ID 901 of “2” (A→B→C→D), two records (a record having the ID 301 of “6” and a record having the ID 301 of “11”) are acquired from the inquiry response table 211, and hence the cumulative number of cases 909 is “2”. In addition, each of the two records has the response period 313 of “8”, and hence the cumulative response period 908 is “16” (=8+8). Accordingly, the average response period 907 is “8” (=16/2).

According to the example shown in FIG. 9, for example, the following can be seen.
According to the escalation path corresponding to the record having the ID 901 of “3”, the escalation has been performed from a responder “A” to a responder “B” and to a responder
According to the escalation path corresponding to record and having the ID 901 of “4”, the escalation does not occur, and the responder “B” assigned in initial assignment processing has answered the inquiry.
According to the escalation path corresponding to the record having the ID 901 of “5”, the escalation has occurred only once.

Hereinbelow, an example of processing performed in the present embodiment will be described.

FIG. 10 shows a flowchart of inquiry response processing.

The inquiry response processing includes reception of an inquiry, an initial assignment of the inquiry, the escalation of the inquiry performed on an as-needed basis, and learning based on the result of processing in the inquiry response processing. In the inquiry response processing, an inquiry response history (among the above-described tables 211 to 217, at least part of the tables 211, 212, 216, and 217) is appropriately updated.

The communication section 201 receives the inquiry (e.g., among one or more questions constituting the inquiry, at least the first question) via the browser 102 of the user terminal 101 from the user (S1001). In this case, the communication section 201 adds the record corresponding to the received inquiry to the inquiry response table 211.

Specifically, the record having the master number 302 corresponding to the inquiry is added. The record includes the record having the sub-number 303 of “00” and the record in which the sub-number 303 is assigned to each question included in the inquiry.

The initial assignment section 202 executes initial assignment processing (S1002). In the initial assignment processing, one previous escalation path is selected and the responder is assigned. A response-target inquiry (a question in an inquiry) is sent to the assigned responder (responder terminal 105) by the communication section 201. Hereinbelow, the responder assigned in the initial assignment processing is referred to as “an initial responder”, and the previous escalation path selected in the initial assignment processing is referred to as “an initial previous escalation path”. Note that “the previous escalation path” denotes an escalation path which is identified from the escalation path table 217, i.e., an escalation path which has been constructed in the previous inquiry response processing. The communication section 201 becomes able to communicate with the initial responder via the responder terminal 105 of the initial responder and the browser 106. In addition, in the initial assignment processing, the initial assignment section 202 updates the record corresponding to the initial assignment in the inquiry response table 211 (e.g., in a record having the sub-number 303 of “01”, the full name of the initial responder is recorded as the responder 306).

The initial responder determines whether or not a further question is made about the inquiry (S1003). For example, in the case where it is determined that questions constituting the inquiry are adequate, the determination result in S1003 is false (S1003:NO).

On the other hand, in the case where it is determined that questions constituting the inquiry are inadequate, the determination result in S1003 is true (S1003:YES). In this case, the communication section 201 receives a request for a question to a user from the initial responder and transmits the request to the user (S1004), and receives an additional question from the user in response to the request (S1005). Thereafter, the processing returns to S1003.

In the case of S1003:NO, or after S1008 described later, the assigned responder (the initial responder or the responder serving as the escalation destination) starts a response to the question in the inquiry (the first question or an escalation-target question) (S1006). The start of the response is input to the communication section 201. The communication section 201 may count an elapsed period from the start of the response. The communication section 201 may record the status 310 and the response start date and time 311 in the record corresponding to the response-target question in the inquiry response table 211. In addition, in the case where the communication section 201 receives the answer for the response-target question from the responder, the communication section 201 may record the answer 305 in the record corresponding to the question, and the response-target question may be the next question for the responder.

The escalation control section 203 determines whether or not the escalation is necessary (S1007). The determination of whether or not the escalation is necessary may be, e.g., any of the following.

(A) Whether or not the response period (the elapsed period from the response start) in S1006 exceeds a period identified from the inquiry response history (e.g., the table 212 or 216).
(B) Whether or not it is determined in the initial assignment processing (S1002) that an inquiry having a priority higher than that of the inquiry during the response in S1006 is received in S1001 and the responder in S1006 is assigned to the inquiry having the higher priority.

In addition, with regard to (A) described above, e.g., at least one of the following may be adopted.

(a1) In the case where the responder is the initial responder, the escalation control section 203 determines whether or not the response period in S1006 exceeds the average response period 416 (the average response period 416 identified from the responder table 212) of the initial responder. In the case where the determination result is true, the escalation is necessary.
(a2) In the case where the responder is the responder serving as the escalation destination, the escalation control section 203 determines whether or not the response period in S1006 after the escalation exceeds the average response period 806 (the average response period 806 identified from the escalation table 216) corresponding to the escalation between the escalation destination and the escalation source of the escalation destination. In the case where the determination result is true, the escalation is necessary.
(a3) In the case where the responder is the responder serving as the escalation destination, the escalation control section 203 determines whether or not the response period in S1006 after the escalation exceeds the average response period 416 of the responder. In the case where the determination result is true, the escalation is necessary.

In the case where the determination result in S1007 is true (S1007:YES), the escalation control section 203 executes escalation processing (S1008). In the escalation processing, the escalation control section 203 may record the status 310 and the response end date and time 312 in the record in which the responder 306 (the full name of the escalation source) and the escalation-target question 304 are recorded. In addition, in the escalation processing, the escalation control section 203 may record the full name of the responder serving as the escalation destination as the responder 306 and may record the full name of the responder serving as the escalation source as the escalation source 309 in the record corresponding to the escalation in the inquiry response table 211. After S1008, S1006 is performed by the responder serving as the escalation destination. The start of the response in S1006 is input to the communication section 201 by the responder serving as the escalation destination. The communication section 201 may count the elapsed period from the start of the response. The communication section 201 may record the status 310 and the response start date and time 311 in the record corresponding to the escalation in the inquiry response table 211.

In the case where the determination result in S1007 is false (S1007:NO), the communication section 201 receives the answer from the responder, and returns the answer to the user (S1009). With this, the response to the inquiry received in S1001 is completed (closed). The communication section 201 may record the status and the response end date and time 312 in the last record corresponding to the inquiry in the inquiry response table 211.

The learning section 204 executes learning processing (S1010).

According to the inquiry response processing described above, in the case where it is determined that the escalation is not necessary for the initial responder, the response to the inquiry is completed without executing the escalation processing (S1008).

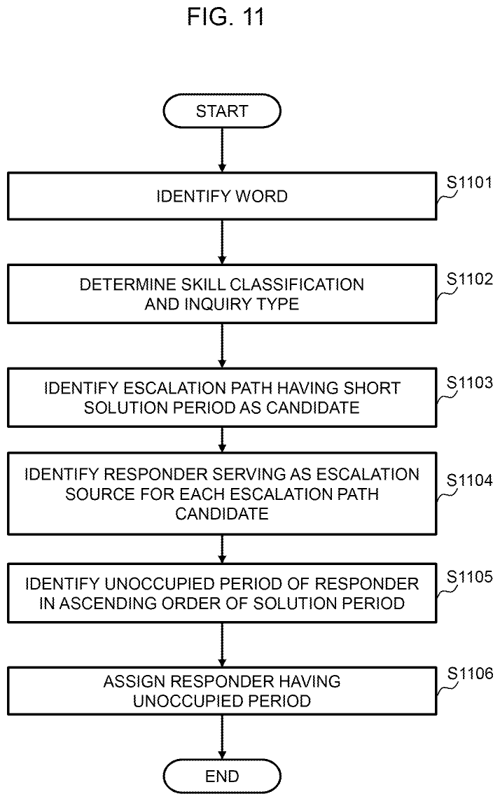

FIG. 11 shows a flowchart of the initial assignment processing.

The initial assignment section 202 identifies a word which corresponds with a word 702 in the word list table 215 from the inquiry (S1101). The initial assignment section 202 determines the skill classification and the inquiry type (e.g., the skill classification and the inquiry type corresponding to the word 702 having the largest number of words which correspond with the word 702) of the inquiry by referring to the skill classification table 213 and the inquiry type table 214 by using the classification number 703 and the type number 704 corresponding to the word having the identified corresponding word as keys (S1102).

The initial assignment section 202 refers to the escalation path table 218, and identifies a candidate for the escalation path having a short solution period from among the escalation paths (the escalation paths corresponding to the skill classification 905 and the inquiry type 906 which correspond with the skill classification and the inquiry type determined in S1102) (S1103). In the description of the initial assignment processing, “the solution period” may be a period represented by the average response period 907 or the cumulative response period 908, and may also be the shortest response period (e.g., the total sum of the shortest response periods 313 (the response periods 313 identified from the inquiry response table 211) of the individual escalations constituting the escalation path). “The candidate for the escalation path having the short solution period” may be an escalation path which satisfies a condition related to the shortness of the solution period. “The condition related to the shortness of the solution period” may be any of the following. As a result, one or more (typically, a plurality of) escalation path candidates are identified.
The shortness of the solution period corresponds to the top N cases (N is a natural number).
The solution period is in a range of not less than the shortest solution period and not more than an adjusted solution period. “The shortest solution period” is the shortest solution period among the solution periods of the escalation paths. “The adjusted solution period” is a solution period which is longer than the shortest solution period and is obtained by adding a predetermined value to the shortest solution period or multiplying the shortest solution period by a predetermined value.
The solution period is shorter than an average of the solution periods of the escalation paths.

The initial assignment section 202 identifies the responder serving as the escalation source 902 from the escalation path table 218 for each escalation path candidate identified in S1103 (S1104).

The initial assignment section 202 identifies the unoccupied period (the period represented by the unoccupied period 407) of the responder identified in S1104 for the escalation path candidate from the responder table 212 in ascending order of the solution period (the solution period mentioned in this paragraph is, e.g., the average response period 907) (S1105). In the case where the identified unoccupied period satisfies a predetermined condition (e.g., the unoccupied period is longer than 0 or the unoccupied period is not less than the solution period of the escalation path candidate), the initial assignment section 202 assigns the responder having the unoccupied period to the inquiry (S1106).

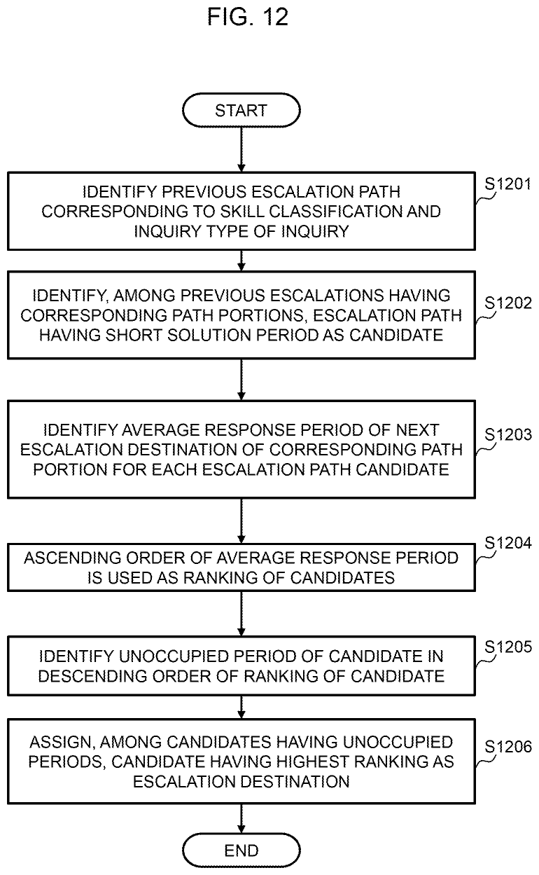

FIG. 12 shows a flowchart of the escalation processing.

The escalation control section 203 identifies all previous escalation paths corresponding to the skill classification and the inquiry type of the inquiry (S1201).

The escalation control section 203 identifies the previous escalation paths each having a corresponding path from the previous escalation paths identified in S1201, and identifies the candidate for the escalation path having the short solution period from the identified previous escalation paths (S1202). “The corresponding path” denotes an escalation path or a path portion which corresponds with a temporary escalation path (an escalation path having been constructed in the inquiry response processing), and the escalation path or the path portion from the first responder. In the escalation processing, the identification of “the candidate for the escalation path having the short solution period” may be similar to that in S1103 in the initial assignment processing. In addition, the escalation path candidate identified herein is “the previous escalation path having the path or the path portion (the path or the path portion from the first responder) which corresponds with the temporary escalation path”, and hence the last responder of the previous escalation path or the path portion and the last responder of the temporary escalation path correspond with each other.

The escalation control section 203 identifies the responder (escalation destination) next to the last responder (escalation source) in the corresponding path for each escalation path candidate identified in S1202, and identifies the average response period 408 of the next responder from the responder table 212 (S1203). The identified average response period 408 corresponds to the skill classification and the inquiry type of the inquiry. In addition, “the next responder” identified for each escalation path candidate is the responder who can be determined to be the escalation destination in this escalation processing, i.e., “a candidate”. Note that there can be cases where “the next responder” is not present, and such cases will be described later.

The escalation control section 203 uses ascending order of the average response periods 806 identified in S1203 as the order of the escalation path candidates, and uses the order as ranking of the candidates identified from the escalation path candidates (S1204).

The escalation control section 203 identifies the unoccupied period (the period represented by the unoccupied period 407) of the candidate in descending order of the ranking of the candidate from the responder table 212 (S1205). In the case where the identified unoccupied period satisfies the predetermined condition (e.g., the unoccupied period is longer than 0), the escalation control section 203 assigns the candidate having the unoccupied period (among the candidates having unoccupied periods, the candidate having the highest ranking) as the escalation destination (S1206). The candidate assigned in S1206 is the next responder.

Note that, in the case where the previous escalation path is not present in S1201, in the case where the previous escalation path having the corresponding path is not present in S1202, and in the case where the entire previous escalation path is the corresponding path (i.e., in the case where the next responder is not present) in S1203, it follows that a new escalation path which has not been constructed before (not recorded in the escalation path table 217) is constructed. In this case, the escalation control section 203 may assign, among all of the responders corresponding to the skill classification and the inquiry type of the inquiry, the responder who has a relatively short average response period 408 (or a relatively short cumulative response period 409) (and has the unoccupied period 407 which satisfies the predetermined condition) as the escalation destination.

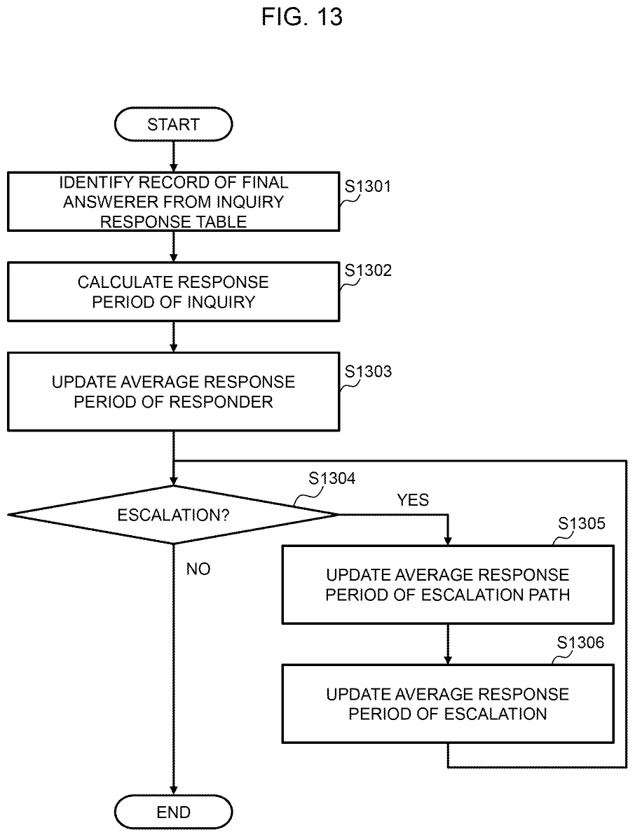

FIG. 13 shows a flowchart of the learning processing.

The learning section 204 identifies the record of the final answerer (the last responder of the escalation path corresponding to the inquiry) from the inquiry response table 211 (S1301).

The learning section 204 calculates the response period 313 from the response start date and time 311 and the response end date and time 312 for each record (the record having the sub-number 303 of “00” is excluded) corresponding to the inquiry in the inquiry response table 211, and records the response start date and time 311, the response end date and time 312, and the response period 313 in the record having the sub-number 303 of “00”.

The learning section 204 updates, for each responder 306 of the record corresponding to the inquiry in the inquiry response table 211, the average response period 408 (and the cumulative response period 409 and the cumulative number of cases 410) (i.e., applicable parts in the responder table 212) corresponding to the responder 403 who corresponds with the responder 306 based on the response period 313 of the responder 306 (S1303).

The learning section 204 refers to the inquiry response table 211 and determines whether or not the escalation on which processing in S1305 and S1306 is not performed is present (S1304). In the case where the determination result in S1304 is false (S1304:NO), the learning processing is ended.

In the case where the determination result in S1304 is true (S1304:YES), the learning section 204 selects the first escalation from the escalations on which the processing in S1305 and S1306 is not performed. The learning section 204 updates the average response period 907 (and the cumulative response period 908) (i.e., applicable parts in the escalation path table 217) corresponding to the escalation path of the inquiry based on the response period 313 corresponding to the escalation (the response period 313 corresponding to the escalation source 309 and the escalation destination (the responder 306) of the escalation)(S1305), and updates the average response period 806 (and the cumulative response period 807) (i.e., applicable parts in the escalation table 216) corresponding to the escalation (S1306). Thereafter, the processing returns to S1304.

Thus, based on the response period 313 of the responder, the average response period 408 (and the cumulative response period 409) of the responder (see FIG. 4) is learned. Based on the response period 313 of the escalation, the average response period 806 (and the cumulative response period 807) of the escalation (see FIG. 8) and the average response period 907 (and the cumulative response period 908) of the escalation path including the escalation (see FIG. 9) are learned.

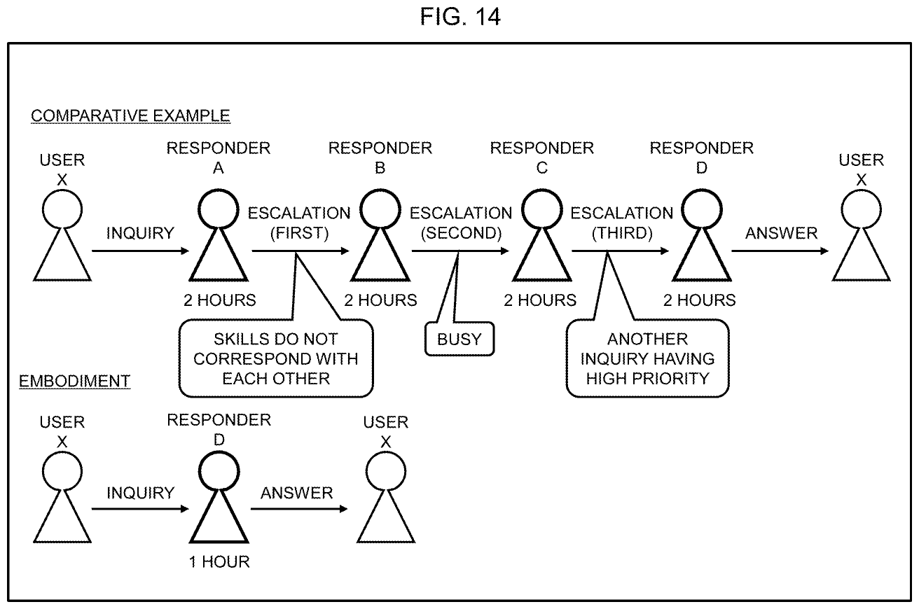

FIG. 14 schematically shows an example of a difference between a comparative example and the embodiment.

According to the comparative example, an assigned responder is not appropriate, and hence many escalations occur and a response to an inquiry needs a long period. For example, an initial responder “A” does not conform to the skill classification and the inquiry type of the inquiry, and hence a response period is increased, and an escalation occurs. A responder “B” serving as the escalation destination is busy, and hence the response period is increased, and an escalation occurs. A responder “C” serving as the escalation destination is responding to another inquiry having a high priority, and hence an escalation occurs.

According to the present embodiment, the inquiry response history is updated every time the inquiry response processing is performed, and the initial assignment processing (and the escalation processing) is executed in the subsequent inquiry response processing based on the updated inquiry response history. Accordingly, as the number of times of execution of the inquiry response processing is increased, a possibility that the responder assigned in the subsequent inquiry response processing is appropriate is increased and, therefore, the escalation path tends to be shortened (as shown in FIG. 14 as an example, the shortest escalation path is constituted only by the initial responder).

The above description can be summarized, e.g., in the following manner. Note that the following summarization may include a supplement to the above description or a description of a modification.

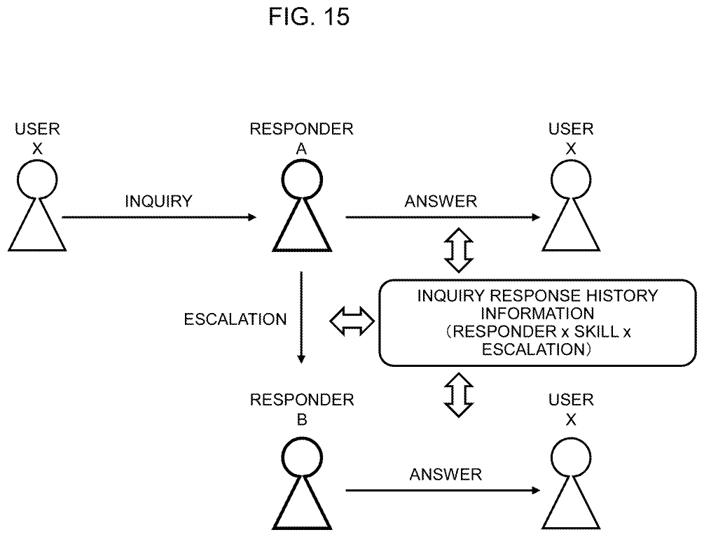

As shown in FIG. 15, the inquiry response history information is provided. The inquiry response history information is information serving as the history of the inquiry response, and is at least part of, e.g., the tables 211, 212, 216, and 217. The inquiry response history information corresponds to information representing correlation among the responder, the skill, and the escalation. The inquiry response history information includes, for each responder, information representing the skill of the responder (e.g., the skill classification 405), and a statistic of the response period which is a period required for the inquiry response (e.g., the average response period 408 (or the cumulative response period 409)). In addition, the inquiry response history information includes, for each escalation, information representing the skill required for the escalation-target inquiry response (e.g., the skill classification 804), information representing the responder of each of the escalation source and the escalation destination of the escalation (e.g., the escalation source 802 and the escalation destination 803), and a statistic of the response period of the escalation (e.g., the average response period 806 (or the cumulative response period 807)). Further, the inquiry response history information includes, for each escalation path, information representing the skill required for the escalation-target inquiry response (e.g., the skill classification 905), information representing the order of one or more responders constituting the escalation path (e.g., the escalation source 902, the escalation destination 903, and the simultaneous escalation 904), and a statistic of the response period of the escalation path (e.g., the average response period 907 (or the cumulative response period 908)). Instead of the average or the cumulative value, the statistic of the response period may be statistics of other types such as, e.g., a median value, a maximum value, and a minimum value.

In the case where the communication section 201 receives the inquiry from the user, the initial assignment section 202 assigns the responder having the skill required for the inquiry to the inquiry based on the inquiry response history information. In the case where answering is performed by the responder, the statistic of the response period of the responder is updated by the learning section 204 based on the response period required by the responder.

The escalation control section 203 determines whether or not the escalation from the assigned responder to another responder is necessary and, in the case where the escalation is necessary, executes the escalation including assigning the responder having the skill required for the received inquiry as the escalation destination based on the inquiry response history information. In the case where answering is performed by the responder serving as the escalation destination, based on the response period required for the escalation (a period required for the response by the responder serving as the escalation destination when the escalation occurs), the statistic of the response period of the responder, the statistic of the response period of the escalation, and the statistic of the response period of the escalation path including the escalation are updated by the learning section 204.

Thus, every time answering to the inquiry (e.g., S1009 in FIG. 10) is executed, the inquiry response history information is updated according to a history from the reception of the inquiry (S1001) to answering (S1009) and, based on the updated inquiry response history information, the assignment of the responder to the next inquiry is performed. With this, the statistics of the response periods of each responder, each escalation, and each escalation path are refined on a skill-by-skill basis, and hence the assignment of the optimum responder is expected to be performed even in the initial assignment or the escalation, and the number of times of occurrence of the escalation related to the inquiry is thereby expected to be reduced.

The initial assignment section 202 may assign any of the first responders of the escalation paths each having the relatively small statistic of the response period to the received inquiry. Thus, the responder is assigned based on the statistic of the response period of the escalation path, and hence the assignment which is unlikely to cause the escalation is expected to be performed. Note that the initial assignment section 202 may assign, among the first responders of the escalation paths each having the relatively small statistic of the response period, the responder having the unoccupied period 407 which satisfies a predetermined condition to the received inquiry. With this, the assignment which is further unlikely to cause the escalation is expected to be performed.

In the case where a period in which the assigned responder responds to the above received inquiry exceeds the statistic of the response period of the responder, or in the case where a period in which the responder serving as the escalation destination responds to the above received inquiry exceeds the statistic of the response period of the escalation, the escalation control section 203 may determine that the escalation is necessary. Thus, it may be automatically determined whether or not the escalation is necessary, and the escalation may be automatically performed on an as-needed basis.

The escalation control section 203 may identify, from among the escalation paths which conform to the skill required for the received inquiry and have the corresponding paths, the escalation paths each having the relatively small statistic of the response period, and may set the next responder of the corresponding path in any of the identified escalation paths as the escalation destination. With this, the assignment in which a possibility that the escalation occurs thereafter is reduced is expected to be performed. Note that the escalation control section 203 may set, among the escalation paths each having the relatively small statistic of the response period, the next responder of the corresponding path who has the unoccupied period 407 which satisfies a predetermined condition as the escalation destination. With this, the assignment which is further unlikely to cause the escalation is expected to be performed.

While the embodiment has been described thus far, the embodiment is only an example for explaining the present invention, and it is not intended to limit the scope of the present invention only to the embodiment. The present invention can be carried out in other various forms.

What is claimed is:

1. An information processing system comprising:
a communication section which receives an inquiry of a user, receives an answer of a responder assigned to the inquiry, and transmits the answer for the inquiry to the user;
an initial assignment section which assigns the responder having a skill required for the inquiry to the inquiry, based on inquiry response history information which is information serving as a history of an inquiry response every time the inquiry is received;
an escalation control section which determines whether or not an escalation from the assigned responder to another responder is necessary and, in a case where the escalation is necessary, executes the escalation including assigning the responder having the skill required for the received inquiry as an escalation destination, based on the inquiry response history information; and
a learning section, wherein
the inquiry response history information includes:
for each responder, information representing the skill of the responder and a statistic of a response period which is a period required for the inquiry response;
for each escalation, information representing the skill required for an escalation-target inquiry response, information representing the responder of each of an escalation source and the escalation destination of the escalation, and a statistic of a response period of the escalation; and
for each escalation path, the information representing the skill required for the escalation-target inquiry response, information representing an order of one or more responders constituting the escalation path, and a statistic of a response period of the escalation path, and
the learning section updates, for each inquiry, the inquiry response history information, based on the skill required for a response to the inquiry, the skill of the responder assigned to the inquiry, the response period required for the inquiry response by the responder, and, in a case where one or more escalations are performed for the inquiry, the response period of each escalation and the response period of the escalation path.

2. The information processing system according to claim 1, wherein the initial assignment section assigns any of first responders of escalation paths each having a relatively small statistic of the response period to the received inquiry.

3. The information processing system according to claim 2, wherein
the inquiry response history information includes information representing an unoccupied period for each responder, and
the initial assignment section assigns a responder, who is selected from among the first responders of the escalation paths each having the relatively small statistic of the response period and has the unoccupied period which satisfies a predetermined condition, to the received inquiry.

4. The information processing system according to claim 1, wherein the escalation control section determines that the escalation is necessary in a case where a period in which the assigned responder responds to the received inquiry exceeds the statistic of the response period of the responder or in a case where a period in which the responder serving as the escalation destination responds to the received inquiry exceeds the statistic of the response period of the escalation.

5. The information processing system according to claim 1, wherein
the escalation control section
identifies, from among escalation paths each of which conforms to the skill required for the received inquiry and has a corresponding path, escalation paths each having a relatively small statistic of the response period, and
sets a next responder of the corresponding path in any escalation path among the identified escalation paths as the escalation destination, and
the corresponding path is an escalation path or an escalation path portion which corresponds with an escalation path constructed for the received inquiry.

6. The information processing system according to claim 5, wherein
the inquiry response history information includes information representing an unoccupied period for each responder, and
the escalation control section sets, among the escalation paths each having the relatively small statistic of the response period, the next responder of the corresponding path, who has the unoccupied period which satisfies a predetermined condition, as the escalation destination.

7. An information processing method comprising:
(A) causing a computer to receive an inquiry of a user;
(B) causing the computer to assign a responder having a skill required for the received inquiry to the inquiry, based on inquiry response history information which is information serving as a history of an inquiry response,
the inquiry response history information including,
for each responder, information representing the skill of the responder and a statistic of a response period which is a period required for the inquiry response, the inquiry response history information including,
for each escalation, information representing the skill required for an escalation-target inquiry response, information representing the responder of each of an escalation source and an escalation destination of the escalation, and a statistic of a response period of the escalation, the inquiry response history information including,
for each escalation path, the information representing the skill required for the escalation-target inquiry response, information representing an order of one or more responders constituting the escalation path, and a statistic of a response period of the escalation path;
(C) causing the computer to determine whether or not an escalation from the assigned responder to another responder is necessary and, in a case where the escalation is necessary, execute the escalation including assigning the responder having the skill required for the received inquiry as the escalation destination, based on the inquiry response history information;
(D) causing the computer to transmit an answer for the received inquiry from the responder to the user; and
(E) causing the computer, every time (A) to (D) are performed, to update the inquiry response history information, based on the skill required for a response to the received inquiry, the skill of the responder assigned to the inquiry, the response period required for the inquiry response by the responder, and, in a case where one or more escalations are performed for the inquiry, the response period of each escalation and the response period of the escalation path.

8. The information processing method according to claim 7, wherein the computer is caused to assign any of first responders of escalation paths each having a relatively small statistic of the response period to the received inquiry in (B).

9. The information processing method according to claim 8, wherein
the inquiry response history information includes information representing an unoccupied period for each responder, and
the computer is caused to assign a responder, who is selected from among the first responders of the escalation paths each having the relatively small statistic of the response period and has the unoccupied period which satisfies a predetermined condition, to the received inquiry in (B).

10. The information processing method according to claim 7, wherein, in (C), the computer is caused to determine that the escalation is necessary in a case where a period in which the assigned responder responds to the received inquiry exceeds the statistic of the response period of the responder or in a case where a period in which the responder serving as the escalation destination responds to the received inquiry exceeds the statistic of the response period of the escalation.

11. The information processing method according to claim 7, wherein,
in (C), the computer is caused to
identify, from among escalation paths each of which conforms to the skill required for the received inquiry and has a corresponding path, escalation paths each having a relatively small statistic of the response period, and
set a next responder of the corresponding path in any escalation path among the identified escalation paths as the escalation destination, and
the corresponding path is an escalation path or an escalation path portion which corresponds with an escalation path constructed for the received inquiry.

12. The information processing method according to claim 11, wherein
the inquiry response history information includes information representing an unoccupied period for each responder, and
the computer is caused to set, among the escalation paths each having the relatively small statistic of the response period, the next responder of the corresponding path, who has the unoccupied period which satisfies a predetermined condition, as the escalation destination in (C).
